(19) United States
(12) Patent Application Publication
(10) Pub. No.: US 2006/0251042 A1
(43) Pub. Date: Nov. 9, 2006

(54) Wireless communication device and wireless communication system

(75) Inventor: Naoto Mikami, Kawasaki (JP)

Correspondence Address: ARENT FOX PLLC, 1050 CONNECTICUT AVENUE, N.W., SUITE 400, WASHINGTON, DC, 20036, US

(73) Assignee: FUJITSU LIMITED

(21) Appl. No.: 11/183,924

(22) Filed: Jul. 19, 2005

(30) Foreign Application Priority Data
Mar. 28, 2005 (JP) 2005-092065

(51) Int. Cl. H04J 3/00

(52) U.S. Cl. 370/345

(57) ABSTRACT

In a wireless communication device to be an access point, a transmitting cycle value of cyclic notifying information transmitted to a wireless communication device connected thereto is selected from a previously prepared setting value group and is set as a transmitting cycle, the cyclic notifying information is transmitted in the transmitting cycle corresponding to the transmitting cycle value selected by each wireless communication device independently and at random in a manner that the cyclic notifying information is transmitted in accordance with the set cycle by a wireless communication to thereby avoid the collision of cyclic notifying information transmitted from different wireless communication devices stochastically.

### CROSS-REFERENCE TO RELATED APPLICATIONS

This application is based upon and claims the benefit of priority from the prior Japanese Patent Application No. 2005-092065, filed on Mar. 28, 2005, the entire contents of which are incorporated herein by reference.

### BACKGROUND OF THE INVENTION

1. Field of the Invention

This invention relates to a wireless communication device and a wireless communication system, particularly, relates to a collision avoidance technology of cyclic notifying information in a wireless communication.

2. Description of the Related Art

In the wireless communication systems compliant with IEEE 802.11 standard such as a wireless LAN, there are systems in which cyclic information are notified at predetermined time intervals. The cyclic notifying information is transmitted by a wireless communication device as a device relaying data (hereinafter, this device is referred to as an “access point”) to a wireless communication device as a terminal connecting to the access point (hereinafter, this device is referred to as a “station”), and the information is called as “beacon”.

One role of the beacon is finding the access point to which the station can be connected, however, the main role thereof is a time management. In the wireless communication system, some special data begins to be transmitted and received, taking the beacon transmission as the opportunity, therefore, the station is required to be able to receive beacons transmitted from the access point.

The station is usually in an active state as a general state, in which data can be received at any time. However, the station having a sleep state as an operating state cannot receive wireless radio waves when being in the sleep state, therefore, the station must be in an awake state, returning once from the sleep state before the beacon is transmitted.

Since there is the possibility of existence of the station which can be in the sleep state in the wireless communication system, the transmission of beacons from the access point cannot be performed irregularly and is performed periodically. The station becomes the awake state in every predetermined cycle, synchronizing with the previously set transmitting cycle of beacon to be able to receive the beacon because of the cyclic transmission of beacons.

In the wireless communication system as described above, a case in which there are two or more access points as shown in FIG. 9A is considered.

FIG. 9A is a view showing one example of the wireless communication system in which there are two access points. In FIG. 9A, AP1 and AP2 denote access points, STA1 to STA6 are stations. Numerals 91 and 92 schematically denote a reaching range of radio waves transmitted from the respective access points AP1 and AP2, and radio waves transmitted from the access points AP1 and AP2 can be received inside the ranges 91 and 92 (in circles).

As shown in the drawing, in the case that there are two or more access points (AP1, AP2 in the example of FIG. 9A), when these access points perform the wireless communication using the same frequency band (channel), the radio frequency interference occurs in an overlapped region of the ranges 91 and 92, depending on a transmitting timing of radio waves. When the radio frequency interference occurs, the station (STA 3 in the example of FIG. 9A) existing in the overlapped region of the radio waves reaching ranges 91, 92 from the access points AP1 and AP2 cannot receive the radio waves normally.

In the conventional art, a plurality of channels that can be used in the wireless communication system are prepared, and a different channel is used when there are two or more access points, namely, the occurrence of the radio frequency interference (the collision of beacons and the like) is avoided by shifting the frequency band to be used. If two or more access points use the same channel, the interference can be avoided when at least one of transmitting cycles or transmitting timings differ from each other, and the possibility that beacons collide is low.

However, due to a constitution in which beacons are transmitted periodically, when the transmitting cycles and the transmitting timings are overlapped, the radio frequency interference inevitably occurs, and beacons transmitted from different access points collide with each other as shown in the times “t91” to “t95” of FIG. 9B. FIG. 9B is a view showing the transmitting timings of beacons from the access points AP1 and AP2, schematically showing time divided discretely to make the explanation be easy to understand. In the case shown in FIG. 9B, the access points AP1 and AP2 cannot perform the wireless communication with the station STA3, and they are unable to communicate with each other.

For example, if the number of access points (density) in the wireless communication system increases in the future, the density of radio waves to be used becomes high because the number of channels has limits. Therefore, the possibility that both the transmitting cycle and the transmitting timing of beacons are overlapped becomes high, accordingly, the possibility that beacons collide also becomes high.

As a conventional art, for example as shown in patent document 1, there is an art in which the control stations perform the communication and exchange data to enable the control of beacons in a wireless communication system having the plural control stations respectively corresponding to the access points. For example, a fine adjustment of the transmitting timing of beacons is performed by temporarily setting beacons having a short cycle. However, there happens to be a region where the radio frequency interference occurs because the communication between the control stations is unable, depending on an arrangement of the control stations. (Patent Document 1) Japanese Patent Application Laid-open No. 2004-40645

### SUMMARY OF THE INVENTION

The object of the present invention is to avoid a collision of cyclic notifying information to be transmitted even if there are plural wireless communication devices to be access points, regardless of an arrangement of these devices.

A wireless communication device of the present invention selects a transmitting cycle value of cyclic notifying information transmitted to a wireless communication device connected thereto from a previously prepared setting value group by a selecting unit, and sets the selected transmitting cycle value as a transmitting cycle of the cyclic notifying information by a setting unit, and transmits the cyclic notifying information in accordance with the set transmitting cycle by a wireless communication.

According to the above constitution, even if there exists plural wireless communication devices transmitting the cyclic notifying information, the collision of the cyclic notifying information transmitted from different wireless communication devices can be avoided stochastically, because each wireless communication device selects the transmitting cycle value from the previously prepared setting value group independently and at random, and the cyclic notifying information is transmitted in the transmitting cycle corresponding to the selected transmitting cycle value.

### BRIEF DESCRIPTION OF THE DRAWINGS

FIG. 1 is a block diagram showing a constitutional example of a wireless communication device according to a first embodiment;

FIG. 2 is a flowchart showing an operation of the wireless communication device in the first embodiment;

FIG. 3A and FIG. 3B are views explaining a wireless communication system in the first embodiment;

FIG. 4 is a block diagram showing a constitutional example of a wireless communication device according to a second embodiment;

FIG. 5 is a flowchart showing an operation of the wireless communication device in the second embodiment;

FIG. 6A and FIG. 6B are block diagrams showing constitutional examples of wireless communication devices according to a third embodiment;

FIG. 7 is a flowchart showing an operation of the wireless communication device (transmitting side of beacons) in the third embodiment;

FIG. 8 is a flowchart showing an operation of the wireless communication device (receiving side of beacons) in the third embodiment; and

FIG. 9A and FIG. 9B are views explaining problems of a wireless communication system including plural access points.

### DETAILED DESCRIPTION OF THE PREFERRED EMBODIMENTS

Hereinafter, some embodiments of the present invention will be described with reference to the drawings.

### First Embodiment

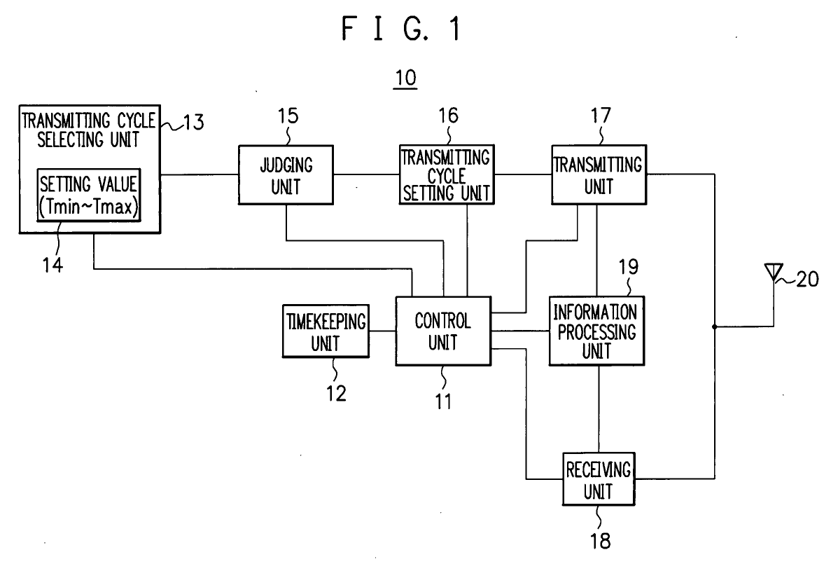

FIG. 1 is a block diagram showing a constitutional example of a wireless communication device 10 according to a first embodiment of the present invention, and illustrates a wireless communication device which is to be an access point in a wireless communication system. Namely, the wireless communication device 10 shown in FIG. 1 transmits beacons as being cyclic notifying information to a wireless communication device such as a station and the like connected thereto in the wireless communication system.

Note that a constitution relating to a transmitting cycle control of beacons in the wireless communication device 10 is specifically shown in FIG. 1. The other constitutions are simply shown or not shown, however, it goes without saying that the device includes a conventionally known constitution functioning as the access point.

The wireless communication device 10 has, as shown in FIG. 1, a control unit 11, a timekeeping unit 12, a transmitting cycle selecting unit 13, a judging unit 15, a transmitting cycle setting unit 16, a transmitting unit 17, a receiving unit 18, an information processing unit 19 and an antenna 20.

The control unit 11 totally controls respective functional units 13, 15 to 19 and the like belonging to the wireless communication device 10. The control unit 11 gives instructions, for example, based on a timekeeping result at the timekeeping unit 12 or a processing result of received data at the information processing unit 19 to manage and control operations of the respective functional units 13, 15 to 19. The timekeeping unit 12 has a timekeeping function to count an operation timing and the like of the wireless communication device 10.

The transmitting cycle selecting unit 13 selects a transmitting cycle value (transmitting interval) of beacons T from a setting value group 14 previously prepared. The transmitting cycle value T is a natural number, and a result of the transmitting cycle value T multiplied by a predetermined unit time (as the unit time, for example, 1 ms or 10 ms) will be the transmitting cycle of beacons.

The setting value group 14 is prescribed by a minimum value Tmin and a maximum value Tmax as the transmitting cycle value of beacons (with respect to the values Tmin, Tmax, results of the values multiplied by a predetermined unit time becomes a minimum value and a maximum value of the transmitting cycle as similar to the value T.) and includes arbitrary natural numbers between the Tmin to Tmax. To cite an example, in the setting value group 14, 50 for the minimum value Tmin and 2000 for the maximum value Tmax are prepared, taking the unit time as 1 ms. It is also preferable that plural combinations of the minimum value Tmin and the maximum value Tmax are prepared to be suitably selectable in accordance with a setting and the like.

In short, the transmitting cycle selecting unit 13 selects the transmitting cycle value T from the prepared Tmin to Tmax selectable as the transmitting cycle value at random. At this time, the transmitting cycle selecting unit 13, for example, makes a selection of the transmitting cycle value T so as to judge whether a value obtained by generating random numbers is the value between Tmin to Tmax or not. Then, the transmitting cycle selecting unit 13 outputs the transmitting cycle value T and the trial number of times in a selection process to the judging unit 15.

The judging unit 15 judges whether the transmitting cycle value of beacons T selected in the transmitting cycle selecting unit 13 satisfies predetermined conditions or not. In the present embodiment, the judging unit 15 judges whether the selected transmitting cycle value T is a prime number or not. As a result, in the case that the transmitting cycle value T is the prime number, the judging unit 15 outputs it to the transmitting cycle setting unit 16, whereas in the case that the transmitting cycle value T is not the prime number, the judging unit 15 requires a reselection of the transmitting cycle value T for the transmitting cycle selecting unit 13.

The judging unit 15 judges how many times the transmitting cycle selecting unit 13 makes selections of the transmitting cycle value T, that is, whether the trial number of times in the selection process of the transmitting cycle value T is equal to or more than predetermined number of times (for example, 10 times) or not. As a result, in the case that the trial number of times are equal to or more than the predetermined number of times, the judging unit 15 outputs the selected transmitting cycle value T to the transmitting cycle setting unit 16 without requesting the reselection of the transmitting cycle value T for the transmitting cycle selecting unit 13.

The transmitting cycle setting unit 16 makes a setting for the transmitting cycle value of beacons T supplied from the judging unit 15 as a transmitting cycle of beacons Ts. The transmitting unit 17 is the unit for transmitting data (information) through the antenna 20 by the wireless communication. The transmitting unit 17, with respect to a transmitting control of beacons, transmits information (beacon) supplied from the information processing unit 19 through the antenna 20 in accordance with the transmitting cycle Ts set by the transmitting cycle setting unit 16.

The receiving unit 18 is the unit for receiving data (information) transmitted by the wireless communication through the antenna 20. The information processing unit 19 performs a generation process of various kinds of data (information) including the information transmitted by the beacons, or various kinds of data processings such as encoding or decoding for data which is transmitted or received.

Next, the operation will be described.

The operation and the like actually transmitting beacons in accordance with the set transmitting cycle of beacons Ts is similar to the conventional operation, therefore, an explanation thereof is omitted. In the following explanation, a setting operation of the transmitting cycle of beacons Ts alone will be explained.

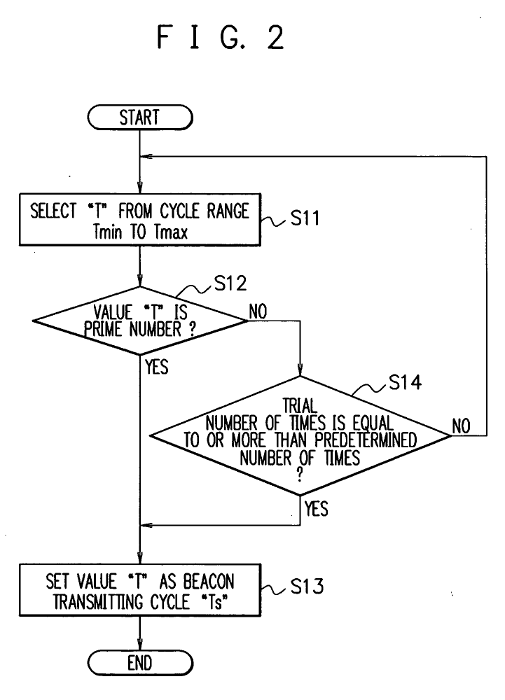

FIG. 2 is a flowchart showing the setting operation of the transmitting cycle of beacons Ts in the wireless communication device 10 according to the first embodiment.

The setting operation is started in the wireless communication device 10, the transmitting cycle selecting unit 13 selects a transmitting cycle value of beacons T at random between Tmin to Tmax prepared as the setting value group 14 (step S11).

Next, the judging unit 15 judges whether the transmitting cycle value T selected in the step S11 is a prime number or not (step S12). As a result of the judgment, in the case that the transmitting cycle value T is the prime number (YES in the step S12), the transmitting cycle setting unit 16 sets the transmitting cycle value T as the transmitting cycle of beacons Ts (step S13) and the setting operation ends.

On the other hand, as a result of the judgment in the step S12, in the case that the transmitting cycle value T is not a prime number (NO in the step S12), the judging unit 15 judges whether the trial number of times in the selection process of the transmitting cycle value T, that is, the execution number of times of the step S11 is equal to or more than predetermined number of times or not (step S14). As the result, in the case that the trial number of times in the selection process of the transmitting cycle value T is not equal to or more than the predetermined number of times (NO in the step S14), the process returns to the step S11 and the transmitting cycle value T is selected. In the case that the trial number of times in the selection process of the transmitting cycle value T is equal to or more than the predetermined number of times (YES in the step S14), the process proceeds to the step 13 and the transmitting cycle setting unit 16 sets the transmitting cycle value T as the transmitting cycle of beacons Ts to end the operation.

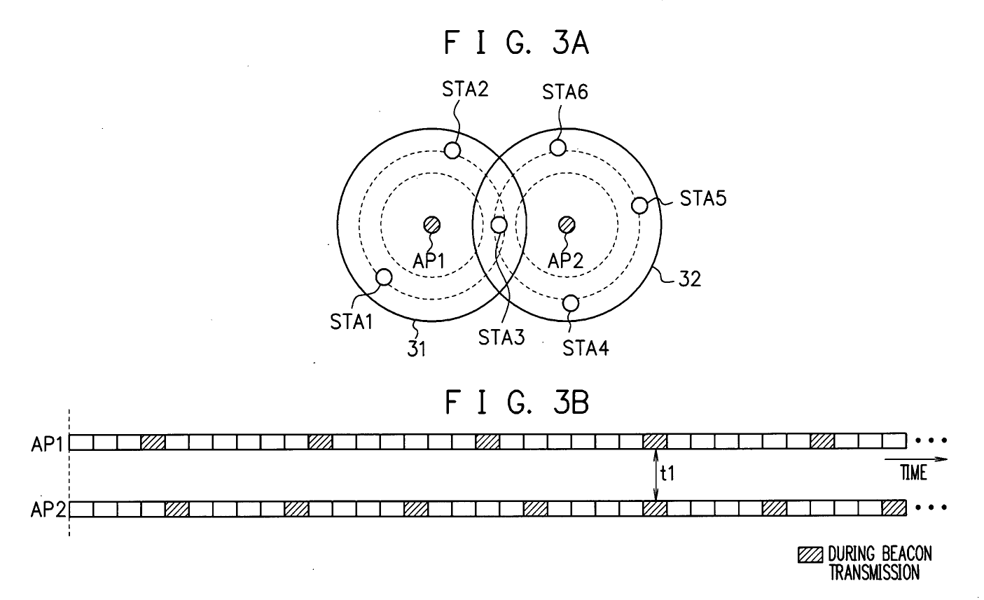

A wireless communication system according to the first embodiment will be described with reference to FIG. 3A and FIG. 3B.

FIG. 3A is a view showing an example of the wireless communication system according to the first embodiment. In FIG. 3A, AP 1 and AP 2 denote access points constituted by the wireless communication device 10 shown in FIG. 1. Numerals 31, 32 schematically show reaching ranges of radio waves transmitted from the access points AP 1 and AP 2, and the radio waves from the access points AP1 and AP2 can be received inside the ranges 31 and 32 (regions inside circles).

STA 1 to STA 6 denote stations and are constituted similarly to the conventional ones. As shown in FIG. 3A, the station STA 3 exists in an overlapped region between the reaching ranges 31 and 32 of the radio waves from the access points AP1 and AP2.

FIG. 3B is a view showing transmission timings of beacons from the access points AP1 and AP2 transmitted in accordance with the transmitting cycle of beacon Ts set in the manner as described above. In FIG. 3B, time is schematically shown, discretely divided in order to allow the explanation to be easy to understand.

As shown in FIG. 3B, the access points AP1 and AP2 perform the control independently, and transmit beacons respectively in the transmitting cycles Ts corresponding to 7 divisions and 5 divisions in FIG. 3B. Therefore, as shown in the time “t1” of FIG. 3B, the beacon transmitted from the access point AP1 collides with the beacon transmitted from the access point AP2 once in five times. Similarly, the beacon transmitted from the access point A2 collides with the beacon transmitted from the access point AP1 once in seven times. In the case the beacons collide with each other, stations being ready to receive the beacon may wait for a next beacon with no operation, or may make inquiries to the access point.

Accordingly, the beacons transmitted from the access points AP1 and AP2 collide with each other once in K times respectively (K denotes the transmitting cycle value of the access point different from oneself), however, they do not collide continuously, therefore, the stations STA 1 to STA 6, especially the station STA 3 existing in the overlapped region between the ranges 31 and 32 can be prevented from being unable to communicate at any time.

As described above, according to the present embodiment, each wireless communication device 10 independently selects the transmitting cycle value of beacons T at random from the prepared setting value group 14 and transmits the beacons, setting the selected transmitting cycle value T as the transmitting cycle of beacons Ts. Accordingly, the collision of the beacons can be avoided stochastically and the devices can be prevented from being unable to communicate without adding any complicated constitution and regardless of an arrangement of the access point (wireless communication device) even if there exists plural wireless communication devices to be the access points and the reaching ranges of radio waves from them are overlapped.

Furthermore, the selected transmitting cycle value T is judged whether it is a prime number or not, and in the case that the transmitting cycle value T is the prime number, it is set as the transmitting cycle of beacons Ts, whereas in the case that it is not the prime number, the transmitting cycle value T is selected again. Therefore, a collision frequency of beacons can be reduced as compared with the case that the selected transmitting cycle value T is set as the transmitting cycle Ts without qualification. It may be possible that the transmitting cycle value T is set as the transmitting cycle Ts without qualification, not making a judgment whether it is a prime number or not, however, it is preferable that the transmitting cycle value T as being the-prime number is set as the transmitting cycle Ts, considering the above.

### Second Embodiment

Next, a second embodiment of the present invention will be described.

In the second embodiment described hereinafter, each wireless communication device selects a transmitting cycle value of beacons T at random and recognizes transmitting cycles of beacons in other wireless communication devices that can be the radio frequency interference, and the transmitting cycle of beacons Ts is allowed to be set in a different cycle from them to thereby certainly avoid continuous collisions of beacons.

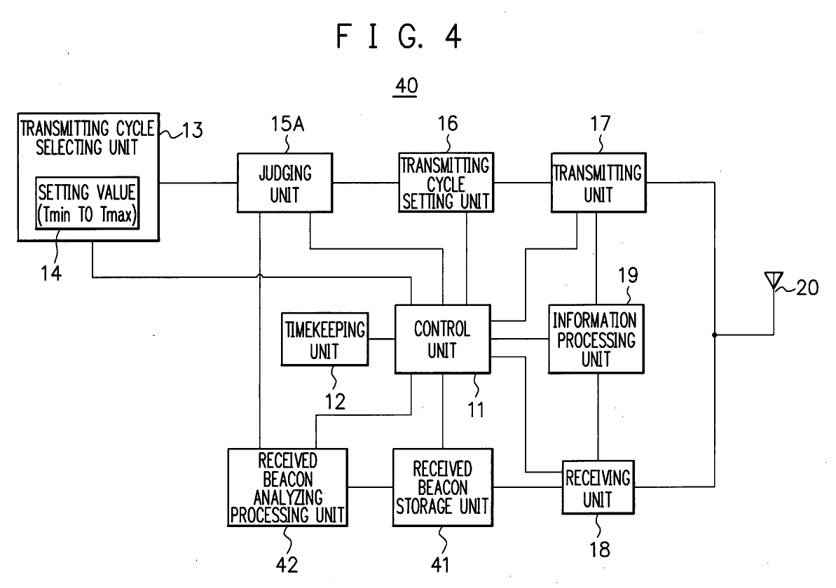

FIG. 4 is a block diagram showing a constitutional example of a wireless communication device 40 according to the second embodiment. In FIG. 4, the same numerals are given to blocks and the like having the same functions as the blocks and the like shown in FIG. 1, and overlapping descriptions are omitted. Also in FIG. 4, a wireless communication device to be an access point in the wireless communication system is shown, and the wireless communication device 40 shown in FIG. 4 transmits beacons as being cyclic notifying information to a wireless communication device such as a station and the like connected thereto in the wireless communication system.

In FIG. 4, similarly to FIG. 1, a constitution relating to a transmitting cycle control of beacons in the wireless communication device 40 is specifically shown, and other constitutions are simply shown or not shown, however, it goes without saying that the device includes a conventionally known constitution functioning as the access point.

The wireless communication device 40 has, as shown in FIG. 4, a control unit 11, a timekeeping unit 12, a transmitting cycle selecting unit 13, a judging unit 15A, a transmitting cycle setting unit 16, a transmitting unit 17, a receiving unit 18, an information processing unit 19, and an antenna 20, additionally includes a received beacon storage unit 41 and a received beacon analyzing processing unit 42.

The judging unit 15A judges whether the transmitting cycle value of beacons T selected in the transmitting cycle selection unit 13 satisfies predetermined conditions or not. In the second embodiment, the judging unit 15A judges whether the selected transmitting cycle value T is a prime number or not and whether the trial number of times in a selection process of the transmitting cycle value T is equal to or more than a predetermined number of times or not, as similar to the judging unit 15 in the first embodiment.

Furthermore, the judging unit 15A judges whether a transmitting cycle of beacons based on the selected transmitting cycle value T differs from transmitting cycles of beacons of other wireless communication devices (other access points) or not. As a result, when the transmitting cycle of beacons based on the selected transmitting cycle value T is same as one of the transmitting cycles of beacons of other wireless communication devices, the judging unit 15A requires a reselection of the transmitting cycle value T for the transmitting cycle selecting unit 13.

The received beacon storage unit 41 stores beacons from other wireless communication devices (access points and stations) received by the receiving unit 18.

The received beacon analyzing processing unit 42 analyzes the received beacons stored at the received beacon storage unit 41, and acquires information relating to transmitting cycles of beacons of other access points. Since the radio frequency interference does not occur in different channels, it is preferable that at least the information relating to the transmitting cycles of beacons at other access points using the same channel can be acquired.

Here, the beacons are generally transmitted only from the access point, however, in the second embodiment, the station transmits beacon-corresponding frames which correspond to the beacons transmitted by the access point. The beacon-corresponding frames are also stored at the received beacon storage unit 41 as the received beacons. The beacon and the beacon-corresponding frame are transmitted inevitably once in a predetermined period of time (within an acceptable period of the maximum beacon transmitting cycle), and for example, a station that can be in a sleep state is awoken to transmit the beacon-corresponding frame. By using the beacon-corresponding frames, the wireless communication device 40 can obtain information relating to the presence of other access points and the transmitting cycles of beacons thereof and the like even if the wireless communication device 40 can not directly perform the wireless communication with other access points.

Next, the operation will be described.

In the following description, a setting operation of the transmitting cycle of beacons Ts alone will be explained, and other operations are similar to the conventional operations, therefore, explanations thereof are omitted.

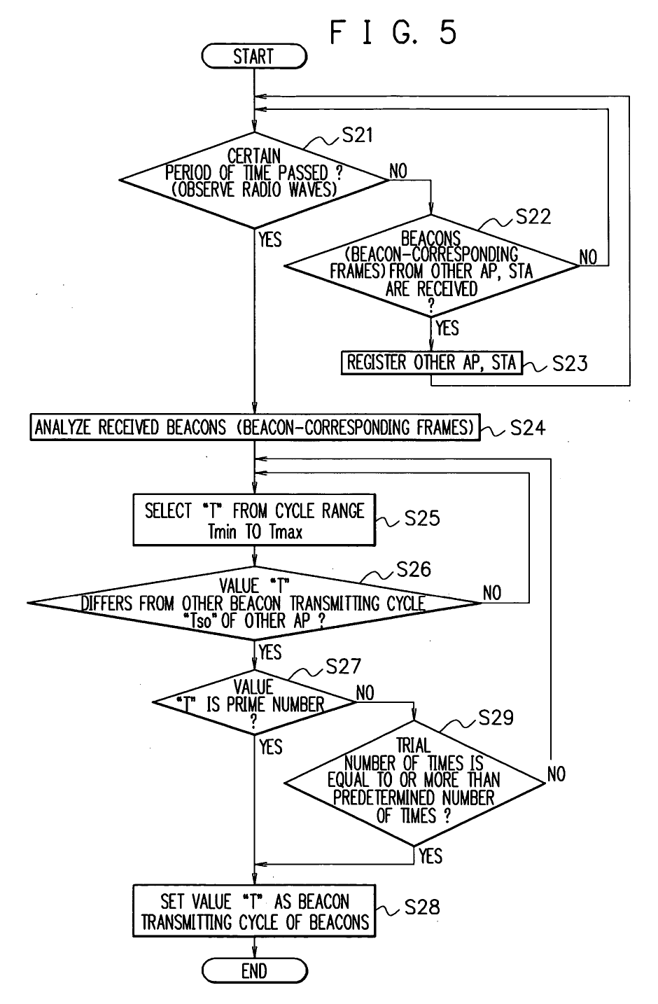

FIG. 5 is a flowchart showing the setting operation of the transmitting cycle of beacons Ts in the wireless communication device 40 in the second embodiment. The operation shown in FIG. 5 is the operation in the case that the wireless communication device 40 is added as a new access point.

When the setting operation of the transmitting cycle of beacons Ts is started, the wireless communication device 40 detects other already existing wireless communication devices (the access points and stations) by monitoring radio waves in the wireless communication for a certain period of time. In the monitoring of the radio waves, when beacons or beacon-corresponding frames transmitted from other wireless communication devices are received, the received beacons or the beacon-corresponding frames are stored and registered at the received beacon storage unit 41 (step S21 to step S23).

When the certain period of time passed from the start of monitoring radio waves (YES at the step S21), the received beacon analyzing processing unit 42 performs an analyzing processing of the beacons and the beacon-corresponding frames received in the monitoring of radio waves and stored at the received beacon storage unit 41 to acquire transmitting cycles of beacons Tso of other access points. By analyzing all beacons and beacon-corresponding frames stored at the received beacon storage unit 41, the transmitting cycles of beacons Tso of all the already existing access points are recognized (step S24).

Subsequently, the transmitting cycle selecting unit 13 selects the transmitting cycle value of beacons T from Tmin to Tmax prepared as a setting value group 14 at random (step S25).

Next, the judging unit 15A judges whether the transmitting cycle of beacons based on the transmitting cycle value T selected in the step 25 differs from the transmitting cycles of beacons Tso of the already existing access points obtained in the step S24 (step S26). As a result of the judgment, the transmitting cycle of beacons based on the transmitting cycle value T is same as one of the transmitting cycles of beacons Tso of the already existing access points (NO in the step S26), the process returns to the step S25, and the selection of the transmitting cycle value T is performed again.

On the other hand, as a result of the judgment in the step 26, when the transmitting cycle of beacons based on the transmitting cycle value T differs from any of the transmitting cycles of beacons Tso of the already existing access points (YES in the step S26), the process proceeds to step 27. Note that the processes in the steps S27, S28 and S29 are respectively similar to the processes in the steps S12, S13 and S14 in the first embodiment, therefore, explanations thereof are omitted.

As described above, according to the second embodiment, the similar effect to the first embodiment can be obtained, and continuous collisions of beacons can be positively avoided by further setting the transmitting cycle of beacons so as to be different from the transmitting cycles of beacons Tso of the already existing access points.

In the first and second embodiments, the transmitting cycle value T is selected from the prepared setting value group 14 at random and whether the value is a prime number or not is judged, however, it is also preferable that a setting value table previously storing prime numbers between Tmin to Tmaz as the setting value group 14 is prepared to select the transmitting cycle value T referring to the table. In this case, the prime number is certainly selected as the selected transmitting cycle value T, and the judgment whether the transmitting cycle value T is a prime number or not is not required, therefore, the process can be speeded up.

### Third Embodiment

Next, a third embodiment of the present invention will be explained.

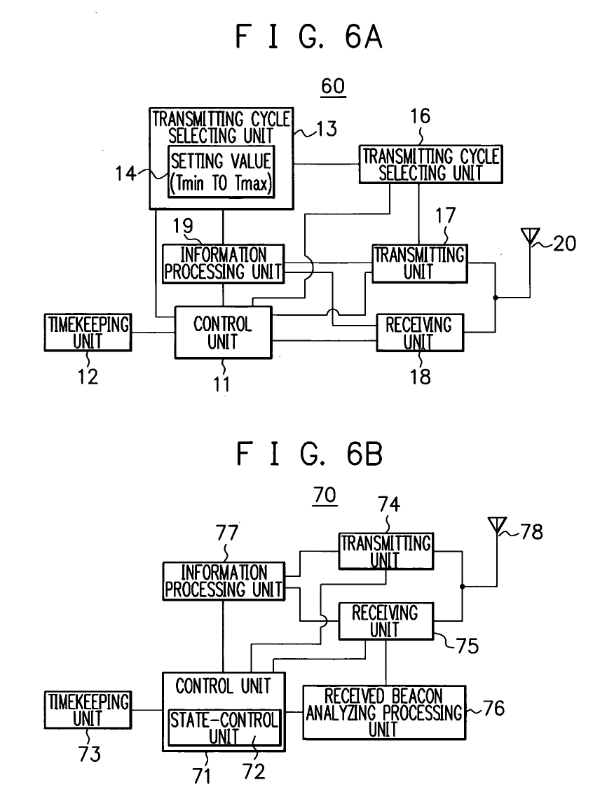

The third embodiment explained hereinafter is constituted so that each wireless communication device can change the transmitting cycle of beacons Ts dynamically. FIG. 6A and FIG. 6B are block diagrams showing constitutional examples of wireless communication devices 60 and 70 according to the third embodiment.

FIG. 6A shows a wireless communication device to be an access point in the wireless communication system, and the wireless communication device 60 shown in FIG. 6A transmits beacons as cyclic notifying information to a wireless communication device such as a station and the like connected thereto in the wireless communication system. In FIG. 6A, the same numerals are given to blocks and the like having the same functions as the blocks shown in FIG. 1, and overlapping explanations are omitted.

FIG. 6B shows a wireless communication device to be a station in the wireless communication system, and the wireless communication device 70 shown in FIG. 6B receives beacons as being the cyclic notifying information from the access point connected thereto in the wireless communication system. In FIG. 6A and FIG. 6B, constitutions relating to a transmitting cycle control and a receiving cycle control of beacons in the wireless communication devices 60 and 70 are specifically shown, and other constitutions are simply shown or not shown, however, it goes without saying that devices include conventionally known constitutions functioning as the access point and the station respectively.

The wireless communication device 60 to be the access point, as shown in FIG. 6A, includes a control unit 11, a timekeeping unit 12, a transmitting cycle selecting unit 13, a transmitting cycle setting unit 16, a transmitting unit 17, a receiving unit 18, an information processing unit 19 and an antenna 20.

In the wireless communication device 60, the transmitting cycle selecting unit 13 outputs a selected transmitting cycle value T to the transmitting cycle setting unit 16 and the information processing unit 19. The information processing unit 19 generates the information to be transmitted by beacons, which includes the information showing the supplied transmitting cycle value T. In the third embodiment, the transmitting cycle selecting unit 13 selects the transmitting cycle value T whenever the beacon is transmitted as described later, therefore, it is desirable to use a setting value table storing setting values as a setting value group 14 for speeding up the selection process.

The wireless communication device 70 to be the station, as shown in FIG. 6B, includes a control unit 71, a timekeeping unit 73, a transmitting unit 74, a receiving unit 75, a received beacon analyzing processing unit 76, an information processing unit 77, and an antenna 78.

The control unit 71 includes a state-control unit 72, totally controlling respective function units 73 to 77 and the like included in the wireless communication device 70. The control unit 71 gives instructions, for example, based on a timekeeping result at the timekeeping unit 73 or a processing result of received data at the information processing unit 77 and the like to manage and control operations of the respective function units 73 to 77.

The state-control unit 72 controls operating states in the wireless communication device 70. As the controllable operating states, there are an active state always being in operating state, a sleep state being an idle state in which the operation is suspended, an awake state being an operating state returned once from the sleep state and the like. The timekeeping unit 73 includes a timekeeping function for counting operation timings and the like of the wireless communication device 70.

The transmitting unit 74 is an unit for transmitting data (information) by the wireless communication from the antenna 78. The receiving unit 75 is an unit for receiving data (information) transmitted by the wireless communication through the antenna 78. The received beacon analyzing processing unit 76 analyzes beacons from the access point received by the receiving unit 75 and acquires time information showing the timing at which a next beacon is transmitted from this access point. The information processing unit 77 performs a generation process of various kinds of data (information) transmitted from the transmitting unit 74 or a various kinds of dada processings and the like such as encoding or decoding of data to be transmitted and received.

Next, operations will be explained.

First, an operation of the access point (transmitting side of beacons) will be described.

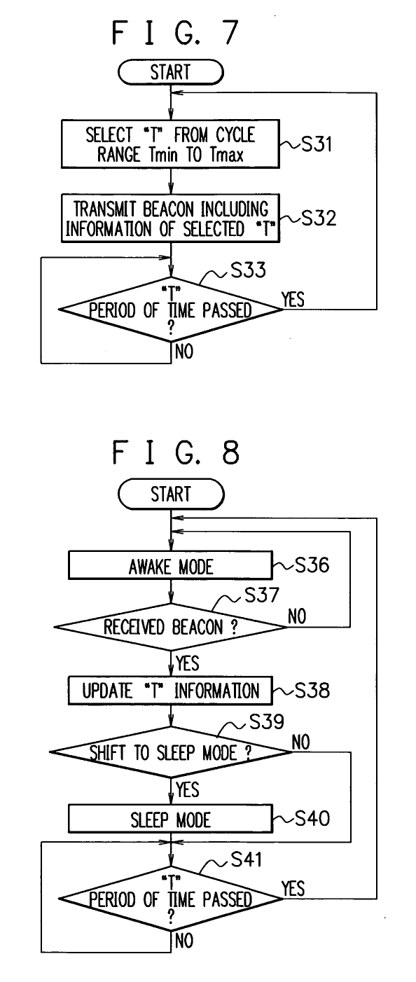

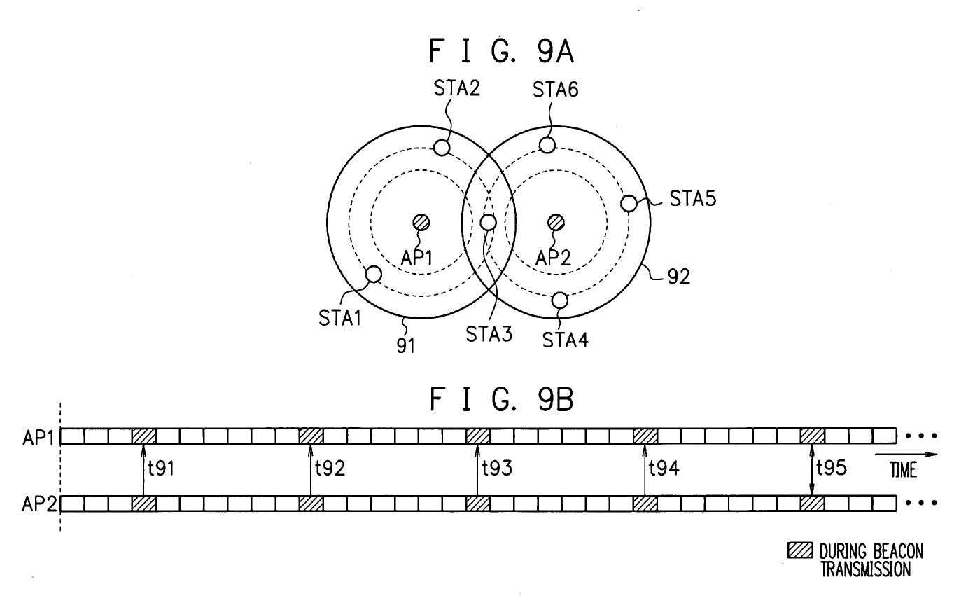

FIG. 7 is a flowchart showing a transmitting operation of beacons at the wireless communication device 60 according to the third embodiment.

The transmitting cycle selecting unit 13 of the wireless communication device 60 selects a transmitting cycle value T of a next beacon from values between Tmin to Tmax prepared as the setting value group at random (step S31).

Next, beacons including information of the selected transmitting cycle value T are generated at the information processing unit 19, then, the transmitting unit 17 transmits the beacon supplied from the information processing unit 19 in accordance with the transmitting cycle of beacon Ts set by the transmitting cycle setting unit 16 (step S32). At this time, the selected transmitting cycle value T is set and updated by the transmitting cycle setting unit 16 as the transmitting cycle Ts of a next beacon.

Then, the wireless communication device 60 waits until the transmitting cycle Ts passes after transmitting the beacon, and when the transmitting cycle Ts passes, the process returns to the step S31 to repeat the above operation.

Next, an operation of the station (receiving side of beacons) will be explained.

FIG. 8 is a flowchart showing a receiving operation of beacons at the wireless communication device 70 according to the third embodiment.

The wireless communication device 70 is, in the case that the operating state is in the sleep state, returns once and shifts to an awake state at the receiving timing of beacon designated by the time information previously set (step S36). After that, the device waits until a beacon from the access point is received at the receiving unit 75 in the awake state (step S37).

When the device receives the beacon from the access point (YES in the step S37), the received beacon analyzing processing unit 76 analyzes received beacon and acquires the time information showing the timing at which a next beacon is transmitted to update the time information set in the acquired time information (step S38).

After the received timing of the next beacon is acquired from the received beacon in the manner as described above, the wireless communication device 70 shifts to the sleep state in the case that the device is configured so as to shift to the sleep state as the operating state (step S40). Whereas, in the case the device is not configured as the above, the step S40 is skipped.

Then, the wireless communication device 70 waits until the time designated by the time information after receiving the beacon, and when the time passes, the process returns to the step S36 to repeat the above-described operation.

According to the above third embodiment, the wireless communication device 60 to be the access point selects the transmitting cycle value of beacons T from the setting value group 14 at random whenever transmitting beacons, and sets the value as the transmitting cycle Ts of a next beacon to transmit the beacon. Thereby, whenever transmitting beacons, the transmitting cycle of beacons can be dynamically changed, as a result, the collision of beacons can be stochastically avoided if there are plural access points. Therefore, continuous collisions of beacons can be avoided and the device can be prevented from being unable to communicate. Concerning the wireless communication device 70 to be the station, a transmitting timing of a next beacon is notified by the beacon, therefore, the wireless communication between the access point and the station can be performed positively when the transmitting cycle of beacons Ts are dynamically changed at the access point.

According to the present invention, the wireless communication device transmits the cyclic notifying information in the transmitting cycle selected from the previously prepared setting value group independently and at random, therefore, the collision of the cyclic notifying information transmitted from different wireless communication devices can be avoided stochastically and the devices can be prevented from being unable to communicate, even if there are plural wireless communication devices transmitting the cyclic notifying information, regardless of the arrangement thereof.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A wireless communication device transmitting cyclic notifying information to a wireless communication device connected thereto, comprising:
a selecting unit selecting a transmitting cycle value of the cyclic notifying information from a previously prepared setting value group;
a setting unit setting the transmitting cycle value selected by said selecting unit as a transmitting cycle of the cyclic notifying information; and
a transmitting unit transmitting the cyclic notifying information by a wireless communication in accordance with the transmitting cycle set by said setting unit.

2. The wireless communication device according to claim 1, wherein the setting value group is prescribed by a minimum value and a maximum value selectable as the transmitting cycle value.

3. The wireless communication device according to claim 2, wherein the transmitting cycle value is selected from arbitrary values between the minimum value and the maximum value at random.

4. The wireless communication device according to claim 2, wherein the transmitting cycle value is selected, referring to a setting value table in which the setting values are stored.

5. The wireless communication device according to claim 1, further comprising:
a judging unit judging whether the transmitting cycle value selected by said selecting unit satisfies predetermined conditions or not, and
wherein transmitting cycle value is set as the transmitting cycle of the cyclic notifying information in the case that the transmitting cycle value satisfies the predetermined conditions as a result of a judgment in said judging unit.

6. The wireless communication device according to claim 5,
wherein said selecting unit selects the transmitting cycle value again in the case that the transmitting cycle value selected by said selecting unit does not satisfy the predetermined conditions as a result of the judgment in said judging unit, and
wherein the transmitting cycle value selected by said selecting unit is set as a transmitting cycle of the cyclic notifying information, regardless of the judgment result by said judging unit in the case that the selection of the transmitting cycle value are performed a predetermined number of times by said selecting unit.

7. The wireless communication device according to claim 5, wherein said judging unit judges whether the transmitting cycle value selected by said selecting unit is a prime number or not.

8. The wireless communication device according to claim 5, wherein said judging unit judges whether the transmitting cycle of the cyclic notifying information based on the transmitting cycle value selected by said selecting unit differs from any of transmitting cycles of the cyclic notifying information in other wireless communication devices.

9. The wireless communication device according to claim 8, wherein said judging unit further judges whether the transmitting cycle value selected by said selecting unit is a prime number or not.

10. The wireless communication device according to claim 1, wherein the transmitting cycle of the cyclic notifying information is allowed to be dynamically changeable.

11. The wireless communication device according to claim 10, wherein the transmitting cycle of the cyclic notifying information is updated whenever the cyclic notifying information is transmitted.

12. The wireless communication device according to claim 10, wherein a transmitting cycle value of a cyclic notifying information to be transmitted next is selected in every transmissions of the cyclic notifying information, and cyclic notifying information to be transmitted including the information relating to the selected transmitting cycle value to be set is transmitted.

13. A wireless communication device receiving cyclic notifying information from a wireless communication device connected thereto, comprising:
a receiving unit receiving the cyclic notifying information transmitted by a wireless communication in accordance with set time information; and
an updating unit updating the set time information, acquiring the time information at which a next cyclic notifying information is transmitted based on the cyclic notifying information received at said receiving unit.

14. The wireless communication device according to claim 13, wherein an operating state is allowed to be in a sleep state until the time designated by the time information after the cyclic notifying information is received by said receiving unit.

15. A wireless communication system in which a plurality of wireless communication devices can communicate by a wireless communication, wherein a transmitting cycle value of cyclic notifying information to be transmitted to other wireless communication devices connected thereto is selected from a previously prepared setting value group, the transmitting cycle value is set as a transmitting cycle of the cyclic notifying information, and the cyclic notifying information is transmitted in accordance with the set transmitting cycle by an arbitrary wireless communication device in the wireless communication system.

16. The wireless communication system according to claim 15, wherein in the case that the transmitting cycle value satisfies predetermined conditions after judged whether the selected transmitting cycle value satisfies the predetermined conditions or not, the transmitting cycle value is set as a transmitting cycle of the cyclic notifying information, and in the case of not satisfying the predetermined conditions, a transmitting cycle value is selected from the setting value group again.

17. The wireless communication system according to claim 15, wherein the transmitting cycle of the cyclic notifying information is allowed to be dynamically changeable.

18. The wireless communication system according to claim 15,
wherein a transmitting cycle value of cyclic notifying information to be transmitted next is selected in every transmission of the cyclic notifying information, and the cyclic notifying information to be transmitted including information relating to the selected and set transmitting cycle value is transmitted in a transmitting side of the cyclic notifying information, and
wherein a time information at which the next cyclic notifying information is transmitted is acquired based on the received cyclic notifying information, and the next cyclic notifying information is received in accordance with the time information in a receiving side of the cyclic notifying information.
